(19) United States
(12) Patent Application Publication
(10) Pub. No.: US 2002/0165795 A1
(43) Pub. Date: Nov. 7, 2002

(54) Electronic product registration system with manufacturer rebate validation and management function

(76) Inventors: Kris Holley, Woodinville, WA (US); Peter J. Junger, Redmond, WA (US)

Correspondence Address: NIXON & VANDERHYE P.C., 8th Floor, 1100 North Glebe Road, Arlington, VA, 22201, US

(21) Appl. No.: 10/120,188

(22) Filed: Apr. 11, 2002

Related U.S. Application Data
(63) Continuation-in-part of application No. 09/509,021, filed on Jul. 25, 2000.
(60) Provisional application No. 60/282,902, filed on Apr. 11, 2001.

(51) Int. Cl. G06F 17/60

(52) U.S. Cl. 705/26

(57) ABSTRACT

An electronic product registration system which manages and validates manufacturer rebate programs to assure that such programs are carried out in accordance with appropriate rules and procedures. The invention reduces or prevents improper rebates from being issued and/or improper product returns from being accepted in connection with products sold with a manufacturer's rebate program or the like. The invention also assures that proper refund amounts are issued for returns when a rebate has been previously provided, as well as provides a tool for enabling the retailer and manufacturer to properly account for refunds and rebates between one another.

### RELATED APPLICATIONS

This application is a continuation-in-part of U.S. application Ser. No. 09/509,021 entitled “Method and Apparatus for Verifying Sale Transaction and Processing Product Returns” and filed Jul. 25, 2000.

This application also claims the benefit of U.S. Provisional Application Serial No. 60/282,902 entitled “ERS System With Manufacturer Rebate Validation and Management Function” and filed on Apr. 11, 2001.

### FIELD OF THE INVENTION

The instant invention relates to the field of electronic registration (ER or ERS) of purchased products, and more particularly, to an improved electronic registration system which manages and validates manufacturer rebate programs to assure that such programs are carried out in accordance with appropriate rules and procedures. The invention reduces or prevents improper rebates from being issued and/or improper returns from being accepted in connection with products sold with a manufacturer's rebate program or the like. The invention also assures that proper refund amounts are issued for returns when a rebate has been previously provided, as well as provides a tool for enabling the retailer and manufacturer to properly account for refunds and rebates between one another. The invention further provides a reporting function that enables the success of rebate programs to be conveniently monitored, as well as enables customers to check on the status their rebate requests.

### BACKGROUND AND SUMMARY OF THE INVENTION

Electronic registration (ER) of product transactions has become available for the purpose of reducing unauthorized returns of purchased products and/or unauthorized warranty repair on purchased products. Electronic product registrations (ER) systems provided for this purpose are disclosed in, for example, U.S. Pat. Nos. 5,978,774, 6,018,719 and 6,085,172, the disclosures of which are all incorporated by reference herein in their entirety.

Electronic registrations system rely on the use of a unique identifier, such as a serial number, for each product that is purchased and for which registration is sought. The serial number (or other form of unique identifier) is obtained at the point of sale for inclusion in a registration database, together with other information, such as a date associated with the transaction. This database can then be accessed in connection with an attempted product return/warranty transaction for the purpose of determining if the specific product being presented by a customer qualifies for return/warranty under applicable return/warranty criteria under which the product was originally sold. Such electronic registration systems may also be used in connection with repair and/or exchange transactions, in addition to returns, by enabling an accurate determination as to whether the product qualifies for any of these actions under the appropriate policies and criteria under which the product was originally sold.

ER system uses pre-established return/repair policies and procedures that are programmed into the system so that the system can perform a check when a product is presented for return to determine if the product qualifies for return, replacement and/or warranty repair based on sales transaction information available in the ERS system for the particular product at issue. Thus, known ER systems include a database of return qualification information (or warranty/replacement criteria) for various manufacturer's which enables the system to make an accurate determination with respect to whether or not a product actually qualifies for return (or warranty/replacement) based on the appropriate criteria. Such ER systems have greatly reduced improper and fraudulent returns and warranty claims.

While such ER systems have proven to be very useful in their current forms, additional improvements in such systems are still desired to give such ERS systems more functionality in operation in order to benefit customers, retailers and/or manufacturers. To this end, the instant invention provides an improved ER system that has increased functionality, by providing an enhancement to known ER systems that can be used to manage, control and/or validate manufacturer rebate programs or the like.

Manufacturer rebate programs have been used extensively in the past in connection with the sale of products. In such rebate programs, the customer is typically provided with a coupon or other rebate offer, that enables the customer to receive a partial refund (or some other credit) of the purchase price of the product from the manufacturer of the product by sending or otherwise providing the coupon or rebate offer to the manufacturer. In other words, in such rebate programs, the customer pays a certain amount for a product when purchasing the product from the retailer. At the time of purchase (or at some other time), the customer is given a rebate coupon or rebate offer that the customer can then use to obtain a refund of part of the original purchase price from the manufacturer by, for example, mailing the rebate offer to the manufacturer. Typically, the rebate is provided to the customer from the manufacturer by mailing a rebate check to the customer. The customer can then cash the rebate check to satisfy the rebate offer.

While such rebate programs are have proven to be a valuable sales and marketing tool in connection some products, there are numerous problems that can occur during implementation of such a rebate program that can adversely affect the success of the program. For example, it is possible that a customer might return the product and also receive the rebate. This possibility is obviously very disadvantageous for the manufacturer, in that substantial revenue is lost and money is actually improperly paid to a person who has not ultimately purchased a product from the manufacturer (due to the fact that it has been returned). Thus, rebate programs have the potential for unscrupulous persons to fraudulently take advantage of a rebate program for the purpose of making money. However, the problem also occurs with honest customers that simply want to return the product for a legitimate reason after they have submitted the rebate request to the manufacturer. Currently, retailers and manufacturers have no satisfactory tool that enables rebate programs to be managed and implemented in a way that assures that only proper rebates are provided, regardless of whether or not a product is returned and/or when a product is returned. There is also currently no satisfactory tool that can be used by a retailer that assures that only proper refund amounts are paid for returns, by taking into account whether or not a rebate has previously been provided to the customer. Thus, rebate programs are currently difficult to manage and police at the retail and manufacturer level. As a result, significant amounts of time and money are wasted in connection with manufacturer rebate programs and the like.

The present invention provides a tool that is implemented in connection with electronic registration (ER) to enable convenient and accurate administration of manufacturer rebate programs and the like. In accordance with the invention, the ER system is used, updated and checked during the course of a rebate program to assure that only proper rebates are provided to customers, that only proper returns are accepted in connection with products having a rebate program, and that only proper amounts of money are refunded to customers who return products for which a rebate program has been established.

As an added feature to ER, this invention allows a retailer in cooperation with it's vendors to properly implement and facilitate a rebate program while minimizing the possibility for fraudulent or otherwise improper rebates or returns of rebated products.

The invention is preferably implemented through software which enables an authorized user of the ERS system (such as a store manager or sales clerk) to check the ER database when a product is presented for return as to whether a rebate has been provided to the customer in connection with the subject product. If a rebate has been provided to the customer, then the sales clerk can determine how much to refund to the customer based on the rebate. For example, if the customer paid $60.00 for the product and received a rebate from the manufacturer of $20.00, then the sales clerk will know (from the ER system) only to refund $40.00 to the customer if the customer wants to return the product. Thus, the ER system prevents the customer from receiving a full refund if the customer has already received a rebate from the manufacturer (or other party). This return/rebate transaction can then be recorded in the ER system so that the retailer and the manufacturer can properly account for the overall transaction (i.e., determine whether the retailer owes the manufacturer a credit or visa versa, depending on the particular circumstances of the transaction).

In order to implement the invention, the ER system is provided with functionality (through software and/or hardware) that enables the rebate process to be tracked with respect to each product that is sold with a rebate offer. In other words, the information is entered into the ER system at various stages of the rebate process. For example, when a rebate request is received from by the manufacturer from the customer, the manufacturer can first check the ER database to determine if the product has been returned. In accordance with the invention, any rebate request must include the serial number or other unique identifier that is used by the ER system and has been recorded at the point of sale by the retailer. Preferably, the rebate offer itself includes a corresponding unique identifier that identifies the particular product for which the rebate offer relates. This enables the manufacturer to access the ER system prior to processing the rebate request in order to check if the product has been returned. If the product has been returned, the manufacturer then knows not to process the rebate request (i.e., not to send a rebate check to the customer). The manufacturer could then send, for example, a letter to the customer explaining that no rebate will be sent due to the fact that the product was returned. On the other hand, if the ER system indicates that the product has not been returned, the manufacturer can then begin the rebate process. In accordance with the invention, the manufacturer would then make an entry in the ER system that indicates that a rebate has been requested and that processing of the rebate has begun (e.g., check request submitted—rebate in process). This information is then available to the retailer or any other authorized user of the ER system.

Once a rebate check is processed and mailed, the manufacturer would again update the ER system to reflect the fact that the rebate has been issued (e.g., rebate check has been mailed). This information is then available through the ER system. Thus, if a customer attempts to return the product after the rebate has been mailed to the customer (but before the rebate check has been cashed), the ER system will indicate this fact to the sales clerk, so that proper procedures can be taken to assure that the customer does not get a full refund and a rebate check. For example, in this situation, the retailer could tell the customer that a check has already been mailed and then provide the customer with only a partial refund that is offset by the rebate amount that the customer will be receiving from the manufacturer. The partial refund can then be entered in the ER system by the retailer so that manufacturer and retailer can properly account for the transaction between themselves.

Once a cancelled check has been received by the manufacturer indicating that the customer has received the rebate check and cashed same, the manufacturer enters this information into the ER system so that the system will indicate upon a query by an authorized person, such as the retailer, that a rebate has been received by the customer. In this way, the retailer will know that the customer has already received a rebate if the customer brings the product back to the retailer for a return/refund. The retailer then has the necessary information available to it in order to make a proper determination as to whether a return should be accepted and, if so, what the proper refund amount is based on any rebate that may have been issued.

In accordance with another aspect of the invention, the ER system can be used to provide reports of the rebate program to the manufacturer and/or the retailer. In other words, due to the fact the each step of the rebate process has been tracked in the ER system, and the fact that return/refund information is available in the ER system, reports can be generated that provide information (either in detailed or summary form) on particular rebate programs for review by the retailer and/or the manufacturer. In this way, the success of the rebate program can be more easily determined with less time and effort as compared to conventional rebate programs. Also, in accordance with the invention, the ER system can be used to provide information to the customer as to the status of a rebate. For example, if the customer calls requesting information on the rebate that has been submitted, the ER system can be used to look-up the rebate status information and advise the customer as to what stage the rebate is at (e.g., not received, received and being processed, check sent, or rebate check cashed). An automated voice recognition system is preferably used enabling customers to access the status information contained in the ER system. In this way customer relations can be improved in an easy and efficient manner.

As is apparent from the above, the invention provides a mechanism that can be used in conjunction with ER systems to implement and manage rebate programs, whether the rebates are offered by the manufacturer or any other entity. The invention can be easily implemented in known ER systems by modifying the system to accept information on products having rebate offers. In this way, the retailer can scan the serial number of a product presented for return and determine from the ER system if a rebate issue exists prior to giving the customer a refund. Also, the ER rebate system can be used by the manufacturer in processing rebates to assure that rebates are not sent for products that have been returned, as well as providing important information about the status of a rebate request to the ER system, so that the retailer has the information available to it when a product is presented for return. The invention can accommodate various types of rebate programs and deal with a variety of different situations that can arise during such a program in an efficient and accurate manner. It is noted that the instant invention can be used, not only for manufacturer mail-in rebate programs but also for instant store credit/cash coupon programs or the like. Thus, the invention enables rebate/coupon programs to be accurately and efficiently implemented (regardless of who is offering the rebate and how), while still enjoying all of the benefits of electronic product registration.

### BRIEF DESCRIPTION OF THE DRAWINGS

Other objects, features, advantages and characteristics of the present invention will become apparent from the following detailed description of the exemplary embodiments, when read in conjunction with the accompanying drawings, in which:

FIG. 1 is a schematic block diagram illustrating an example of an overall electronic product registration (ER) system that may be used in accordance with the present invention;

FIG. 2 is a high level flow chart of some of the main steps performed in accordance with prior electronic product registration (ER) systems;

FIG. 3 is a high level flow chart of the main steps performed by a retailer in accordance with the preferred embodiment of the ER rebate system of the instant invention;

FIG. 4 is a high level flow chart of the main steps performed by a manufacturer in accordance with the preferred embodiment of the ER rebate system of the instant invention; and

FIG. 5 is a high level flow chart illustrating some of the main steps performed by the ER system itself in connection with the ER rebate system of the instant invention.

### DETAILED DESCRIPTION OF PREFERRED EMBODIMENTS

The present invention is described in the context of particular exemplary embodiments. However, it will be recognized by those of ordinary skill that modification, extensions and changes to the disclosed exemplary embodiments may be made without departing from the scope of the instant invention. In short, the following descriptions are provided by way of example only, and the present invention is not limited to the particular preferred embodiments disclosed herein, except as indicated in the pending claims.

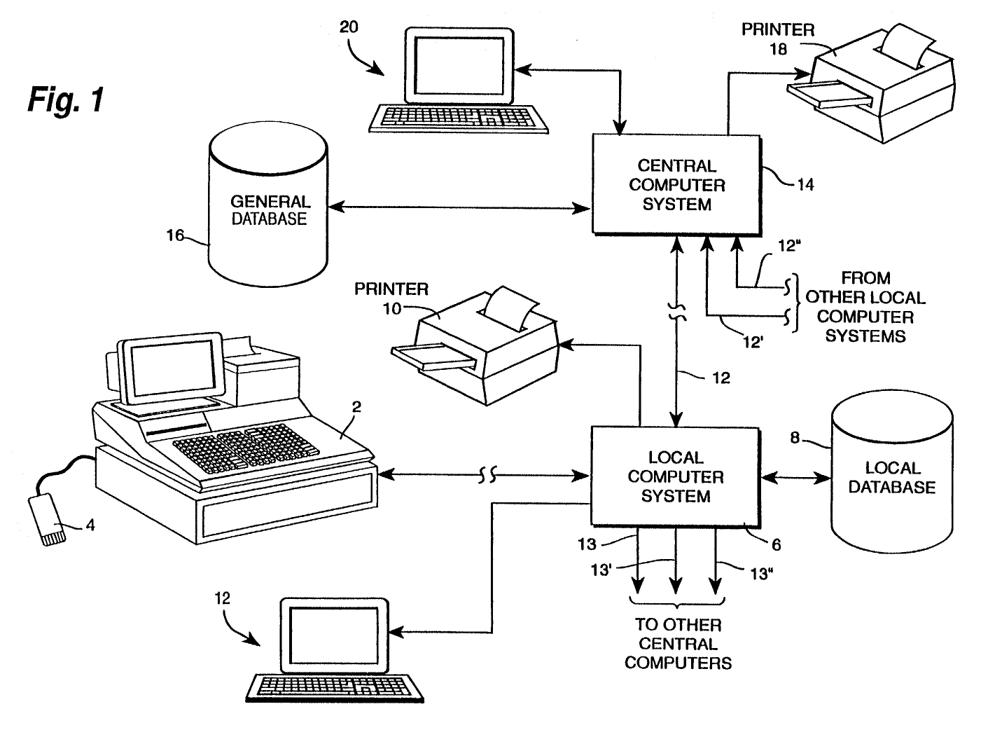

An example of one type of electronic product registration (ER) system that is preferably used in connection with the instant invention is illustrated in FIG. 1. Briefly, this example system includes a point of sale register 2 and an associated bar code scanner 4. The register 2 is preferably connected with a local computer system 6 in any suitable manner. In certain situations (e.g., single store retailers), it may be advantageous to have the local computer system 6 located in proximity to the register 2. For large chain stores, however, it may be advantageous to situate the local retailer computer 6 at a central location with links to the registers 2 at individual stores. The particular arrangement will depend on the preferences and circumstances of the specific retailer and may vary in accordance therewith.

The local retailer computer system includes an associated local database 8 for storing registration information. Additionally, a local printer 10 and an operator terminal 11 may be provided. The operator terminal may be used, for example, by a store clerk upon return of merchandise to locate pertinent sales information in the local database 8. The printer 10 may be used to produce hard copies of, for example, end-of-day sales reports and/or the like.

In the exemplary embodiment, a communication channel 12 is provided between the retailer computer system 6 and a central computer system 14. The central registration computer system may, for example, be an independent registration center computer system which electronically registers product transactions for a number of different retailers. In other words, the central computer system may be operated by a third-party service provider.

A general registration database 16 is associated with the central registration computer system 14 for storing transaction information from a plurality of retailer computer systems 6. Additionally, a printer 18 and an operator terminal 20 may be included with the central registration computer system 14. The central registration computer system may maintain a number of data files pertaining to individual retailers, manufactures and the like. These data files include information applicable to the particular individual retailer, distributor, manufacturer or the like and are preferably maintained by that particular individual or entity. For example, a data file may contain specific return/warranty policy information applicable to that particular individual or entity.

It should be appreciated that the central computer system 14 is preferably intended to handle product registrations for a number of different manufacturers and/or other vendors. Accordingly, the general registration database may employ a structure wherein the product registrations for each participating vendor is maintained in separate areas. Alternatively, separate databases may be employed for each participating vendor. Of course, other data structures may be employed so long as the registration center is able to properly keep track of the product transaction information and particular return and/or warranty policies associated with each transaction.

As illustrated in FIG. 1, the central registration computer system 14 may have a number of additional communications links 12′, 12″, etc. for receiving information from other local computer systems. Thus, for example, a registration center may receive information from a number of different retailers. Additionally, the local computer system 6 may include a number of additional communication channels 13, 13′, 13″, etc. for connecting with other central computer systems. Accordingly, an individual retailer can electronically register products with a number of different registration databases, if desired. Furthermore, a number of communication channels 15, 15′, 15″, etc. can be provided for communications between the central registration computer system 14 and individual manufacturer computer systems and computer systems of third party service providers, law enforcement agencies and/or the like. Of course, a general access channel such as an internet connection may also be made available for authorized access to the central computer system 14.

The electronic registration process begins when a customer brings merchandise to the register 2 for check-out. The sales clerk enters the SKU number which identifies the type of product involved in the transaction (e.g., Super Nintendo Entertainment System, Nintendo Game Boy, Nintendo N64, etc.) by, for example, scanning a UPC product code included on the product packaging. Of course, key entry or another technique for entering the SKU number may be used. Electronic registration might not be necessary for a substantial number of small commodity products (e.g., batteries, candy, diapers, etc.) that are commonly sold by retailers. Accordingly, a check may be made, based on the type of product as identified by the UPC code, to determine whether this is a product for which electronic registration is desired. If so, the store associate is prompted to enter the serial number (or other unique identifier) of the individual item.

The serial number may be entered, for example, by scanning a serial number printed on the packaging. Alternatively, the serial number as it appears on the product may be scanned through a window in the packaging. This alternative ensures that the individual product is identified even if it is mispackaged. Also, repackaging of returned merchandise would be simplified. Other techniques, such as key entry, may also be used. Because the serial number is unique to each individual product, it acts as individual production identification information.

Once the serial number is entered, a check may be made to ensure that the serial number is valid. If not, the store associate is again prompted to enter the serial number. This is repeated until a valid serial number is obtained. Once the serial number is verified, a local database may be updated with the serial number information and any other necessary or desired information. At minimum, however, the local database should include an indication of the date on which the transaction took place. Other information might include the price paid, the store associate responsible for the sale, and the like.

The serial number of the individual product is preferable printed as part of a written customer transaction receipt. The serial number may be printed adjacent the description and SKU number of the registered product. Thus, it will be a simple matter to correlate serial numbers with associated products, particularly when several registered products appear on a single customer sales receipt. Of course, additional information may be printed as well.

The date of the transaction will typically be printed at either the beginning or the end of the sales receipt, but may appear anywhere on the receipt. After the serial number is printed, a check is made to determine whether sales are complete. Ordinarily, this will be based on the store associate hitting a TOTAL button on the cash register. Thereafter, the central registration computer system 14 is contacted and the general registration database 16 is updated with the transaction information.

Inasmuch as ER systems are known, further specific details regarding ER systems themselves will not be provided herein except as needed for a complete understanding of the invention. As seen from the above description of an ER system, there is no functionality in the conventional ER system to implement rebate programs or to manage such programs at the manufacturer or retail level. The ER system does, however, preferably include the policies of both the vendor and the retailer and enables the policies of both parties to be easily and conveniently enforced.

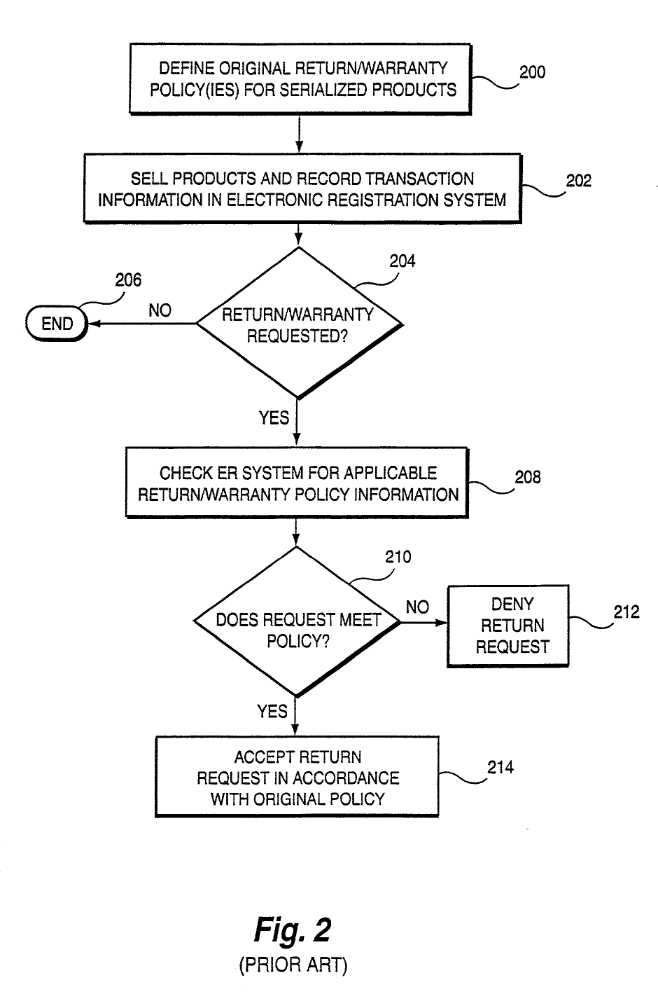

FIG. 2 shows the main steps performed in connection with conventional ER systems. As shown in FIG. 2, the return/warranty policy(ies) are defined for serialized products and entered into the ER system (step 200). The ER system uses the policies and the sales transaction information, as well as the date on which a return is requested, to determine if the product qualifies for return when presented for return. Thus, when the products are sold, the sales transaction is recorded in the ER database (step 202). If the consumer is satisfied with the product, then the process ends (step 206). On the other hand, if a return is requested (step 204), the ER system is accessed to obtain the return qualification information for the specific product being presented for return (step 208). In accordance with conventional ER systems, the return request is handled based on the return qualification information provided by the ER system based on the original policies under which the product was originally sold. Thus, based on the return qualification information provided by the ER system, a determination is made as to whether or not the product qualifies for return/warranty repair or the like (step 210). If the product does qualify for the action requested, the request can be honored by the retailer and the transaction can be completed (step 214). On the other hand, if the ER system indicates that the product does not qualify for the requested action, the customer is typically denied the return or warranty repair (step 212). Of course, the store clerk could decide, for some reason, to ignore the ER information and accept the product anyway. There is, however, no mechanism in convention ER system for handling rebate programs in addition to the general electronic registration functions provided by such systems.

The instant invention provides an improved ER system that enables rebate programs to be easily and efficiently implemented and managed with confidence that they will not be subject to abuse, fraud or other disadvantageous events.

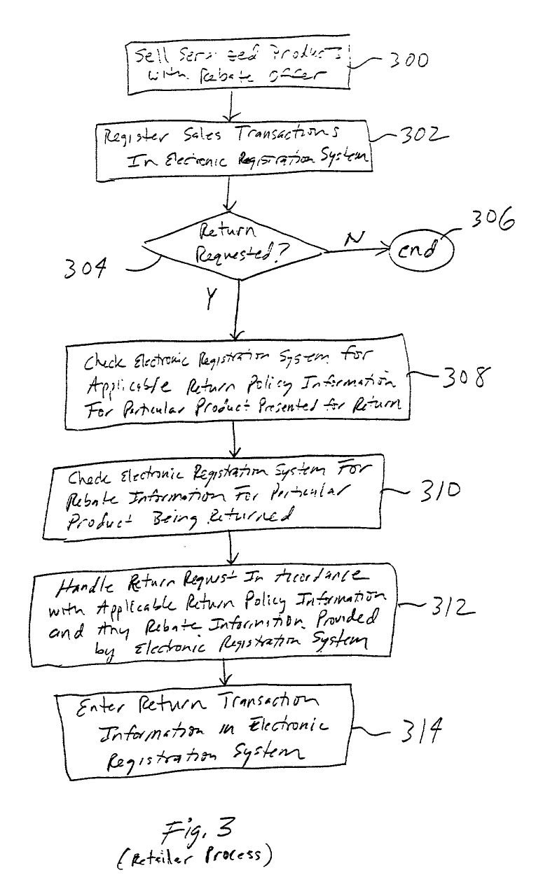

FIG. 3 shows the main steps performed in connection with the preferred embodiment of the instant invention from a retailer's perspective. As shown in FIG. 3, the process starts by having the retailer offer from sale serialized products with a rebate offer (step 300). The rebate offer may, for example, be in the form of a mail-in rebate card attached to the product itself that is removed by the sales clerk at the time of sale or by the customer at a later time. The rebate card preferably includes the same serial number (in barcode form or otherwise) as is on the product being purchased. This assures a correspondence between the rebate card and the product, thereby enabling both the product and the status of the rebate to be specifically tracked in the ER system.

The retailer also uses the ER system in the conventional manner to record sales transactions for the serialized products that are sold. If no return request is received the process ends as far as the retailer is concerned (step 306). If a return request is presented for a serialized product (step 304), the sales clerk checks the ER system in a conventional manner for applicable return policy information so that a decision can be made as to whether the product qualifies for return under the original return policy (step 308). In addition, the ER system is checked for any rebate information for the specific product presented for return (step 310). For example, the ER system is checked to see if a rebate has already been provided in connection the particular product at issue. Based on this information (i.e., return qualification information and rebate status information) the sales clerk is able to handle the return in accordance with the applicable return policy and the status of any rebate offer associated with the product. In this way, only proper returns are accepted and only proper refund amounts are refunded. If a return is accepted, the return transaction is entered into the ER system for future reference as well (step 314). For example, if the manufacturer receives a rebate request, the return information will be available to the manufacturer through the ER system so that an improper rebate is not issued for a returned product.

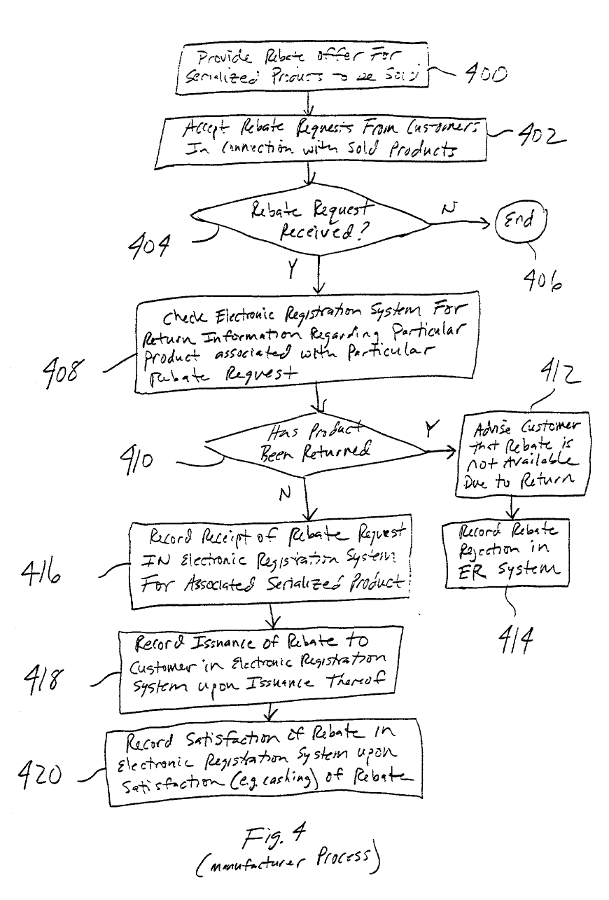

FIG. 4 shows the main steps performed by a manufacturer in accordance with the ER rebate system of the instant invention. As shown in FIG. 4, the process starts by having the manufacturer define and provide a rebate offer for serialized products to be sold (step 400). Once the products are sold, the customers have the option of sending the rebate coupon to the manufacturer (or third party service provider) in order to get the rebate. Thus, the manufacturer accepts the rebate coupons from the customers in connection with sold products (step 402). If no rebate requests are received (which is typically unlikely) the process ends for the manufacturer (step 406). On the other hand, when a rebate coupon is received by the manufacturer, the manufacturer first checks the ER system to see if the particular product associated with the particular rebate coupon has been returned to the retailer (step 408). If the ER system indicates that the product has been returned, the manufacturer knows not to issues a rebate check to the customer. However, in order to advise the customer, the system may be programmed to issue a letter to the customer which advises the customer that no rebate can be provided due to the return (step 412). The fact that the rebate has been rejected can also be indicated in the ER system for future reference (step 414).

If the ER system does not indicate that the product has been returned, then the manufacturer knows that the rebate coupon should be processed to have the rebate issued. In accordance with the invention, the manufacturer then indicates in the ER system that a rebate request has been received and that it is being processed (step 416). In this way, the retailer can see that a rebate has been received by the manufacturer and that it is being processed, if a customer happens to present the particular product associated with the particular rebate coupon to the retailer for return. Since the rebate is only being processed at this point and has not yet been issued, the system could operate such that the customer is give a fill refund and the rebate processing by the manufacturer is stopped, or the retailer could give the customer only a partial refund that equals the purchase price minus the rebate amount. The particular manner in which this situation is handled by the ER system may vary depending on the desires of the parties involved.

Once the rebate request is processed by the manufacturer and a rebate check is mailed, that fact is entered into the ER system by the manufacturer so that the retailer will have that information available should the customer attempt a return of the product corresponding to the mailed rebate check (step 418). In this way, the retailer will know not to issue a complete refund due to the fact that the customer will be receiving the rebate check. Once the rebate check has been cashed so that the rebate has been satisfied, this information is also preferably entered in the ER system, so that this information is available to the retailer and the manufacturer if desired (step 420). For example, the retailer would know that a customer has received the rebate and cashed it if the customer tries to return the product. This does not necessarily mean that the product cannot be returned, but it does mean that the retailer will only pay a reduced refund based on the rebate amount. One advantage of the invention, is that the ER system can advise the retailer as to the appropriate amount of refund based on the status of the rebate offer.

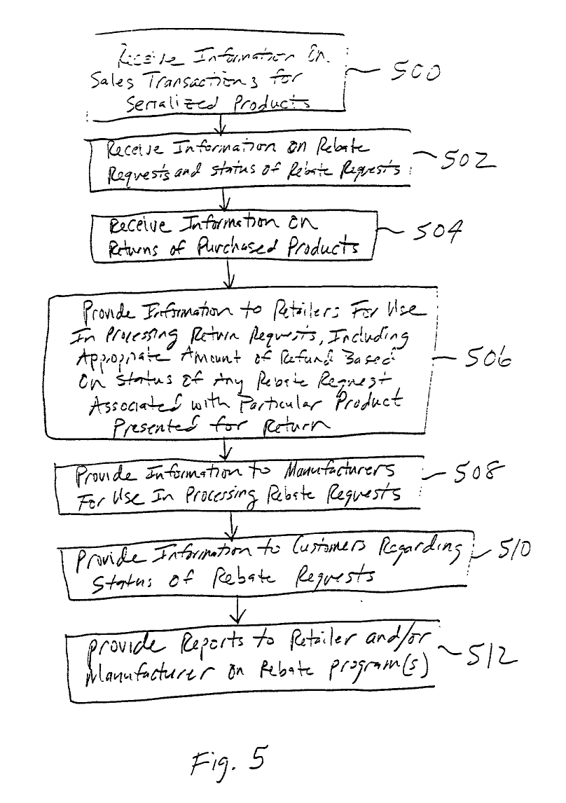

FIG. 5 shows some of the main functions performed by the ER system in connection a preferred embodiment of the instant ER rebate invention. One function is to receive information on sales transactions for sales of serialized products (step 500). Another function is to receive information on rebate requests and the status of rebate requests (e.g., rebate received and being processed, rebate processed and check mailed, rebate check cashed) (step 502). Another function of the ER rebate system is to receive information on returns of purchased products (e.g., date of return, amount refunded)(step 504). As explained above, another function is to provide retailers, upon request, with the information needed to process return requests, including applicable return qualification information and rebate information, as well as the proper refund amounts based on the status of a rebate request (step 506). In addition, as explained above, the ER system provides information to manufacturers for enabling them to make a decision as to whether or not a rebate request should be processed based on whether or not the product associated with the rebate request has been returned (step 508). In addition, the ER rebate system of the present invention preferably provides information to customers, using a telephone system, the Internet or other network, about the status of the customers rebate requests. For example, the ER system may tell the user the stage at which the rebate request is at (e.g., rebate received and being processed, rebate processed and check mailed, rebate check cashed)(step 510). In addition to assuring that rebate requests and returns requests are properly handled, the ER rebate system of the instant invention also preferably provides reports on the rebate programs being implemented through the system (step 512). For example, the rebate reports may provide information on the number or rebate requests received, the status of each rebate request, the number of returns of products associated with the rebate program, etc. This reporting feature enables the rebate programs to be easily and efficiently monitored and evaluated for performance.

As can be seen from the description above, the instant ER rebate system provides a tool that is implemented in connection with electronic registration (ER) to enable convenient and accurate administration of manufacturer rebate programs and the like. The ER rebate system is used, updated and checked during the course of a rebate program to assure that only proper rebates are provided to customers, that only proper returns are accepted in connection with products having a rebate program, and that only proper amounts of money are refunded to customers who return products for which a rebate program has been established. As an added feature to ER, this invention allows a retailer in cooperation with it's vendors to properly implement and facilitate a rebate program while minimizing the possibility for fraudulent or otherwise improper rebates or returns of rebated products, thereby helping to assure successful rebate programs.

What is claimed is:

1. A method of managing a product rebate program on an electronic product registration system for serialized products, comprising:
providing a rebate offer in connection with the sale of serialized products;
recording sales transactions for the serialized products in the registration system;
recording rebate requests in connection with the serialized products in the registration system;
in response to a product return request, obtaining return qualification information and rebate request information from the registration system; and
handling the product return request in accordance with the return qualification information and rebate request information.

2. The method as defined in claim 1, wherein providing a rebate offer includes providing a rebate coupon having thereon an identifier that identifies the serialized product corresponding to the rebate coupon.

3. The method as defined in claim 1, wherein the recording rebate requests includes recording information on the receipt of a rebate request and on a status of processing of the rebate request.

4. The method as defined in claim 3, wherein the status of the rebate requests indicates whether or not a rebate has been sent to a requester.

5. The method as defined in claim 4, wherein the status of the rebate request indicates whether or not the rebate has been satisfied.

6. The method as defined in claim 1, further including indicating, in response to a return request, an appropriate refund amount for use by a sales clerk in handling a refund that takes into account the rebate status information.

7. The method as defined in claim 6, wherein taking into account the rebate status information includes determining whether or not a rebate has been issued, and providing an indication as to the appropriate refund amount by subtracting a rebate amount from a purchase price.

8. The method of claim 1, further including generating reports based on the rebate status information.

9. The method of claim 1, further including enabling customers to access the electronic registration system and providing information to the customers on the status of a rebate request made by customers.

10. The method of claim 9, wherein enabling customers to access the electronic registration system includes providing a voice response unit that interfaces with the electronic product registration system.

11. A method of managing a product rebate program on an electronic product registration system for serialized products, comprising:
providing rebate offers in connection with the sale of serialized products;
registering sales transactions for serialized products in the registration system;
registering product returns in the registration system for serialized products;
upon receipt of a rebate request, obtaining return information from the registration system to determine if the rebate request should be processed;
if the return information indicates a return has been made, rejecting the rebate request; and
if the return information does not indicate that a return has been made, processing the rebate request.

12. The method of claim 11, further including recording the fact that the rebate request is being processed in the registration system.

13. The method of claim 12, further including recording a status of the processing of the rebate request at a plurality of stages thereof.

14. The method of claim 13, wherein the plurality of stages include, rebate being processed, rebate mailed and rebate satisfied.

15. The method of claim 11, further including generating reports based on the rebate status information.

16. The method of claim 11, wherein rejecting the rebate request includes notifying the requester that the rebate request has been rejected and a reasons why it has been rejected.

17. The method of claim 16, further including recording in the registration system that the rebate request has been rejected.
